(19) United States
(12) Patent Application Publication
(10) Pub. No.: US 2017/0122629 A1
(43) Pub. Date: May 4, 2017

(54) ADSORBER STRUCTURE

(71) Applicant: Mahle Behr GmbH & Co. KG, Stuttgart (DE)

(72) Inventors: Roland Burk, Stuttgart (DE); Thomas Wolff, Muenchberg (DE)

(73) Assignees: Mahle Behr GmbH & Co. KG, Stuttgart (DE); Mahle Behr GmbH & Co. KG, Stuttgart (DE)

(21) Appl. No.: 15/106,301

(22) PCT Filed: Dec. 2, 2014
(86) PCT No.: PCT/EP2014/076260

§ 371 Date: Jun. 19, 2016

(30) Foreign Application Priority Data
Dec. 19, 2013 (DE) 10 2013 226 732.0

(51) Int. Cl. F25B 35/04; B01J 20/20; B01J 20/28; F28F 13/18

(52) U.S. Cl. CPC F25B 35/04; F28F 13/187; B01J 20/20; B01J 20/28023; B01J 20/28033

(57) ABSTRACT

An adsorber structure for an adsorption heat exchanger may include directed transport structures for the transport of at least one of heat and adsorptive vapours. The transport structure may be substantially aligned with a gradient direction.

### CROSS-REFERENCE TO RELATED APPLICATIONS

This application claims priority to German Patent Application No. 10 2013 226 732.0, filed Dec. 19, 2013, and International Patent Application No. PCT/EP2014/076260, filed Dec. 2, 2014, both of which are hereby incorporated by reference in their entirety.

### TECHNICAL FIELD

The present invention relates to an adsorber structure. The invention also relates to an adsorption heat exchanger with such an adsorber structure and three methods for producing said adsorber structure.

### BACKGROUND

Thermally powered sorption heat pumps and refrigeration plants have enormous potential in terms of energy saving because heat, not electricity is used to supply their operating power. When a heat pump is used, not only is the calorific value of a heat cell but also an exergy component of the fuel is used to raise extra environmental heat to the required heating temperature level. For cooling applications inexpensive waste heat or excess heat from solar thermal or cogeneration-coupled systems can be used to relieve the burden on electricity networks, particularly in harm time or climate zones where the need for cooling power is greatest. In this context, adsorption systems that use porous solid materials and do not contain fast moving parts—since wearing parts are susceptible to breakdown—are particularly attractive.

The objective of the known adsorption-refrigeration plants is to accommodate as much sorption-active mass—activated carbon for example—per volume as possible. For this, it is necessary to provide an adsorptive material in the thickest layers possible, which are thermally well connected to a heat transfer structure and enable rapid effective adsorptive vapour diffusion.

To ensure that they are attractive enough, these adsorptive structures must exhibit particular physical features, such as high thermal conductivity and microporosity. The sorption isotherms of the adsorbent itself must be perfectly adapted for the application case.

A species-related adsorber structure for a heat exchanger and an adsorption heat pump or adsorption cooler that contains at least one such adsorber structure is known from DE 10 2006 008 786 A1. The adsorber structure comprises an open-pore, thermally conductive solid body and a sorption material arranged on the inner surface of said solid body as for vapour adsorptive purposes. A flat, fluid-tight, thermally conductive element, preferably a fluid-tight foil is arranged on the external surface of the open-pored solid body, at least in the areas where contact with a heat carrier fluid is intended, wherein the adsorber structure is designed so that heat can be exchanged between the open-pored solid body and the heat carrier fluid via the fluid-tight element.

A sorption heat transfer wall having a carrier structure besides macro-, meso- and microstructures for transporting heat and matter is known from WO 2007073849 A2.

An adsorption heat pump consisting of multiple hollow elements, each with a adsorption-desorption area and a vaporization-condensation or phase change area is known from WO 2007/068481 A1. A heat transporting fluid is passed through the hollow elements in each area, the interconnection between the hollow elements for purposes of fluid transit being altered cyclically by means of valve arrangements. The function and power density of such a system is affected to a decisive degree both by the equilibrium and material data of the substance pair used, consisting of one absorbent and one adsorptive substance, and by the kinetics of the sorption processes associated with the adsorptive and absorbent substances.

A species-related adsorber structure (working material store) consisting of a large number of sheet metal panels on which a thermally conductive sorption agent is disposed, is also known from DE 10 2009 015 102 A1.

A method for producing an adsorber heat exchanger in which essentially a monolayer of adsorber particles is attached adhesively to the surface of a heat exchanger structure is described in DE 10 2005 058 624 A1. The drawback in this case is the monolayer, that is to say it does not accommodate very large quantities of adsorber. Consequently, systems that operate on the basis of this technology require a great deal of space.

An adsorber element consisting of a carrier to which adsorber particles are attached adhesively with the aid of a colloidal binding agent, wherein said adsorber layer also comprises fibres is known from DE 10 2008 050 926 A1. The fibres serve to lend a certain elasticity to the adsorber layer, which may be up to 500 μm thick, and help to prevent shrinkage cracks during drying.

One disadvantage shared by the known adsorber structures is that their design is complex and therefore expensive, since the adsorber structure must be in good thermally conductive contact with a metallic carrier structure or heat transfer wall, created for example by soldering or adhesion. A further disadvantage in this context is that the requirement for high thermal conductivity of the macrocarrier structures can only be achieved using copper alloys or aluminium alloys, and these are not sufficiently compatible with the intended use of methanol as the working material.

As was explained in the introduction, most of the existing technologies are only suitable for thin adsorber layers/structures and are designed accordingly, and the associated thermal cycling inevitably results in a poor relationship between latent and perceived output. Moreover, in order to realize the most compact systems possible, high adsorber mass per construction volume is necessary, and this requires thick adsorber layers with sufficiently good thermal conductivity. This gives rise to a conflict of objectives with the kinetics of the desorption and adsorption process. Because the thicker the adsorber layer is, the more heating and transporting matter is lost in the structures, since the driving gradients have to be built up over a longer path.

### SUMMARY

The present invention therefore concerns itself with the problem of suggesting an adsorber structure and an adsorption heat exchanger equipped therewith, which solves the conflict of objectives between a large attached adsorber mass and high sorption kinetics without the use of metal auxiliary structures to enlarge the surface area. It is also intended that the solution should be manufacturable with known, inexpensive processes that are suitable for use in mass production.

This problem is solved according to the invention by the objects of the independent claims. Advantageous variants are the object of the respective dependent claims.

The present invention is based on the general idea of equipping an adsorber structure initially with directed transport structures transporting heat and adsorptive vapours, wherein the transport structures are aligned substantially in the gradient direction. The adsorber structure according to the invention thus has predominantly directed, particularly linear transport structures, wherein the actual adsorber mass is located adjacent to the transport structures in the form of thermally conductive fibres and/or microvapour channels with low tortuosity, and exchanges the adsorptive vapour via the adjacent vapour and/or microvapour channels, and exchanges the sorption heat with the thermally conductive fibre, which is also adjacent. The transport structures may be formed by organic and/or inorganic fibres or by vapour channels which are left behind thereby after a pyrolysis process. In this bionic concept, each adsorbing particle of the adsorber material is connected by extremely short paths on the one hand to at least one (micro-) vapour channel and on the other to a thermally conductive fibre, in a manner similar to the biological example of the lung. Since each active element (an adsorbing particle corresponds to an alveola) has direct access to both transport systems, relatively high, volume-specific sorption kinetics is achieved.

In this context, the term sorption kinetics is used to refer to the speed of the thermal and material transport processes, some of which take place sequentially, others simultaneously, with the given driving temperature and pressure gradient. The adsorber structure according to the invention may also be of considerably thicker design than the adsorber layers known previously from the prior art, since the vapour channels and the thermally conductive fibres which at least partly penetrate the adsorber structure in the gradient direction also guarantee efficient sorption kinetics in the interior of the adsorber structure. The thermally conductive fibres may also consist of a different material from that of the fibres that leave behind the vapour channels through pyrolysis, so that in general two kinds of fibres may be used to produce the adsorber structure.

In an advantageous development of the solution according to the invention, the fibres have the form of thermally conductive fibres and are connected to a first surface of the adsorber structure, while the vapour channels are constructed to be closed in the direction of the first surface and at least partly open in the direction of an opposite, second surface toward the vapour chamber. In this way, it is thus possible to connect each adsorbing particle via extremely short, that is to say low-loss paths, not only to the adsorptive pressure of the free space or the surrounding atmosphere via at least one ((micro-)vapour channel, but also to a heat transfer surface for example, particularly a heat transfer wall, via a thermally conductive fibre. The interstitial spaces between the individual fibres and the vapour channels left behind thereby are filled with adsorber material, activated carbon, for example, with the result that the adsorber structure has a large mass of adsorber material relative to its volume, and consequently also has good ad-sorber capacity and performance.

The fibres and/or the vapour channels left behind thereby following a pyrolysis process are aligned substantially parallel to each other, and they may be either linear or also slightly serpentine. If they are parallel, this ensures that the distance between a vapour channel and a neighbouring thermally conductive fibre is always uniform, so that each ad-sorber particle is arranged not only close to a vapour channel but also close to a thermally conductive fibre. The smaller the distances are between the individual vapour channels and the thermally conductive fibres, the more effectively the sorption kinetics functions.

The adsorber structure practically includes a first layer with a powder/binder mixture with thermally conductive particles, preferably of expanded graphite, graphite powder, BN, SiC or AlN, and an adjoining second layer with high-porosity adsorber powder and a binder, based on alumosilicates, for example. The first layer is connected to the first surface of the adsorber structure, that is to say towards a heat exchanger, while the second layer is aligned the second surface so as to be open toward a vapour chamber or a vapour flow channel. The first layer is thus intended to enable improved thermal contact with a heat transfer surface, and for this reason the powder/binder mixture introduced into the spaces between the fibres has a high content of thermally conductive particles, in particular>30 M.-%. In this way, the thermal connection of the ends of the thermally conductive fibre to the heat transfer surface is better, which in turn increases the sorption kinetics.

The invention is based on the further general idea of describing a method for producing an adsorber structure, as described previously, in which short fibres (chopped fibres) are embedded in an adsorber structure in a largely vertical direction to the thermal connection surface. In this context, it is suggested to use and combine subprocesses that have already been proven successful in other applications in lending fibres within a compound or composite a predominant direction in order to manufacture the adsorber structure.

In a first optionally usable method, fibres or a fibre mixture of a thermally conductive and/or pyrolysable material is/are bonded with an adhesive surface by electrostatic flocking. Then, the interstitial spaces between the individual fibres are filled out with the described mixtures of thermally conductive particles, adsorbent and binder particles, and optionally further additives, optionally compressed and dried, after which the adsorber structure is finally sintered, at which time the organic fibre components are pyrolysed to create the vapour channels necessary for transporting the adsorptive vapours.

Vibration, blowing, brushing and/or elutriation processes are used to introduce mixtures of adsorbent and binder particles into the interstitial spaces of the “lawn” created in this way, and the adsorbent/binder mixture can be treated in either the wet or dry state.

In a second alternative method, short fibres of uniform length (chopped fibres) or milled fibres (fibres non-uniform length) are compounded together with the adsorbent powder and a binder as well as other additional auxiliary materials in a defined mass ratio and fed to an extruder in accordance with the state of the art. By the use of shearing and stretching effects on the feed path to an extrusion die, the fibres may be aligned predominantly in the direction of extrusion according to techniques known from injection moulding and extrusion technology. Shear flows may be created through interstitial spaces and stretching of the extrudate may be created by conical feed geometries to the extrusion die.

Further important features and advantages of the invention are revealed in the subclaims, the drawings and the associated description of the figures with reference to the drawings.

Of course, the features described in the preceding text and those that will be explained subsequently can be used not only in the combination described in each case, but also in other combinations or alone, without departing from the scope of the present invention.

Preferred embodiments of the invention are represented in the drawings and will be explained in greater detail in the following description, in which the same reference signs are used to refer to identical or similar or functionally equivalent components.

### BRIEF DESCRIPTION OF THE DRAWINGS

In the drawing, the figures represent diagrammatically:

FIG. 1 a cross section through an adsorber structure according to the invention, with enlarged details of the area of a first and a second surface,

FIG. 2 a representation as in FIG. 1, but with transport structures extending at an angle to the respective surfaces resulting from shearing compaction,

FIG. 3 a representation as in FIG. 2, but with serpentine transport structures resulting from vertical compaction,

FIG. 4 a representation as in FIG. 3, but with a two-layer adsorber structure,

FIG. 5 an adsorber structure according to the invention produced by an extrusion process,

FIG. 6 an adsorber structure according to the invention having extruded vapour channels, produced by an extrusion process.

### DETAILED DESCRIPTION

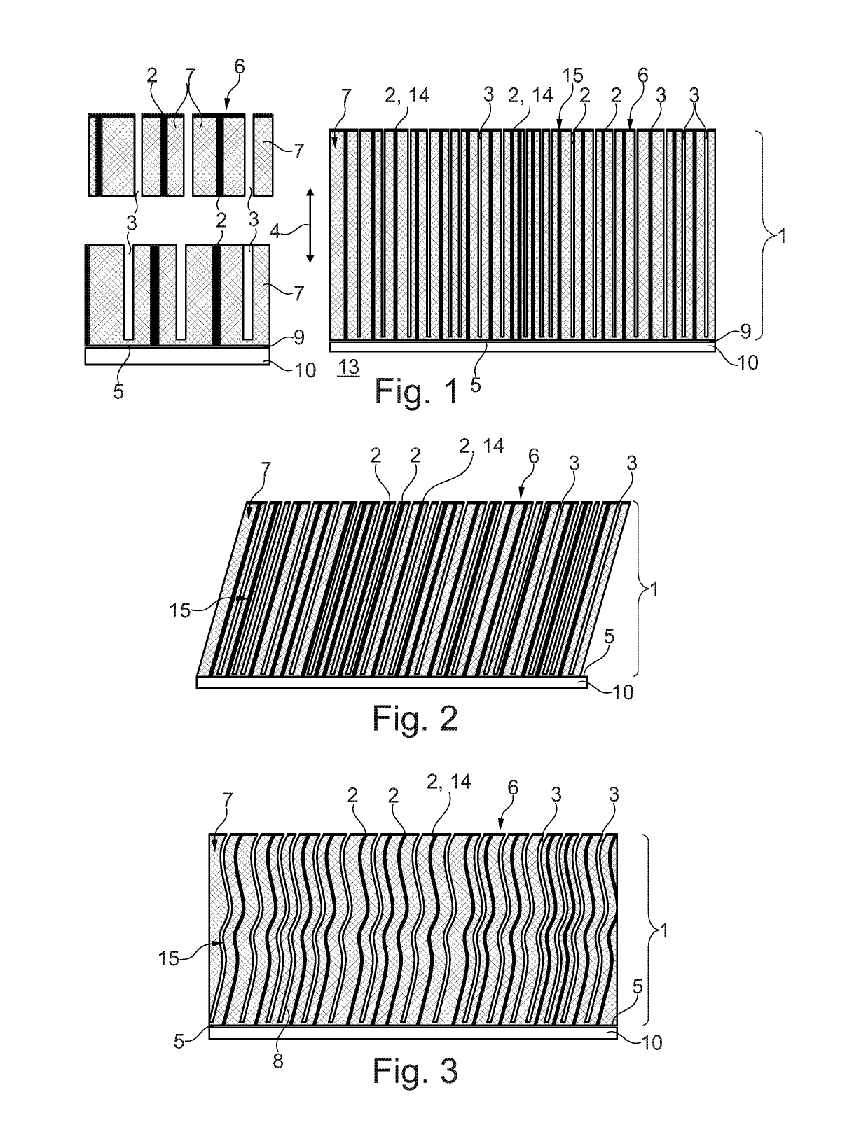

As shown in FIGS. 1 to 4, an adsorber structure 1 according to the invention includes transport structures 15 for transporting heat and adsorptive vapours, wherein transport structures 15 are formed by organic and/or inorganic fibres 2 and/or the vapour channels left behind thereby after a process of pyrolysis, and are essentially aligned in gradient direction 4. Fibres 2 have the form of thermally conductive fibres and are connected to a first surface 5 of the adsorber structure 1, whereas vapour channels 3 are closed towards first surface 5 and at least partially open towards an opposite, second surface 6 of the adsorptive vapour chamber, as is illustrated particularly clearly in the enlarged representation of FIG. 1. An adsorber material 7, for example activated carbon, is arranged between the individual fibres 2 and vapour channels 3. Upon examination of FIG. 1, it may be seen that fibres 2 as well as the vapour channels 3 created therefrom by the pyrolysis process are substantially perpendicular to first surface 5 at their point of incidence therewith. As with the adsorber structures 1 shown in FIGS. 2 to 5, fibres 2 and the vapour channels 3 are incident on first surface 5 and also on the opposite, second surface 6 at an angle. Fibres 2 may thus be made from non-pyrolysable thermally conductive fibres as well pyrolysable organic fibres, which largely disintegrate in the pyrolysis process, thus leaving behind the vapour channels 3. Given a relatively dense arrangement of fibres 2 and thus also of vapour channels 3, high sorption kinetics, that is to say low-loss transport of heat and vapours may be achieved.

The inclined alignment of fibres 2 and vapour channels 3 may be an unintended but tolerable side effect of a shearing, compacting compression of adsorber structure 1, carried out to increase the density and mechanical strength of the adsorber structure. The individual fibres 2 and the vapour channels 3 created therefrom are preferably aligned substantially parallel to each other, so that with an appropriate choice of the fibre mass fractions in the compound, each adsorbing particle is arranged not only as closely as possible to a thermally conductive fibre 2 but also as closely as possible to a vapour channel 3.

In general, adsorber structure 1 is connected directly or indirectly to a heat exchanger element 10, particularly a wall of an adsorption heat exchanger 13, for example a sorption heat pump or a sorption refrigeration plant, via an adhesive layer 9. However a purely non-positive thermal attachment of the adsorber structure to the wall of an adsorption heat exchanger 13 is conceivable instead of adhesive layer 9.

In order to produce the adsorber structure 1 illustrated in FIGS. 1 to 4, chopped fibres for example, made from a highly thermally conductive and/or readily pyrolysable material may be bonded, particularly vertically, to an adhesive surface, in this case adhesive layer 9, by electrostatic flocking, which may be carried out particularly inexpensively using a throughput flocker, for example. It should be noted that the primary adhesive layer for use in the flocking process does not necessarily have to be identical to the adhesive layer used for bonding the structure to heat exchanger wall 13. It may also be in the form of a self-adhesive foil or similar, for example, which is peeled off and thrown away after one of the method steps that will be described later.

In a second process step following the flocking process, the interstitial spaces of the “lawn” created from upright fibres 2 is filled with a mixture of adsorbent and binder particles. A number of known application methods are suitable for this purpose, to ensure that the bulk density of the composites of adsorber structure 1 that are to be produced thereby is as high as possible. In this context, vibration, blowing, brushing and/or slurrying methods of a dry or aqueous mixture may be cited. The density of the thermal contact and/or the strength of the composite may be increased yet further by various compaction processes, for example by compacting either perpendicularly or at an angle, whereby particularly the adsorber structures 1 shown diagrammatically in FIGS. 2 to 4 may be produced.

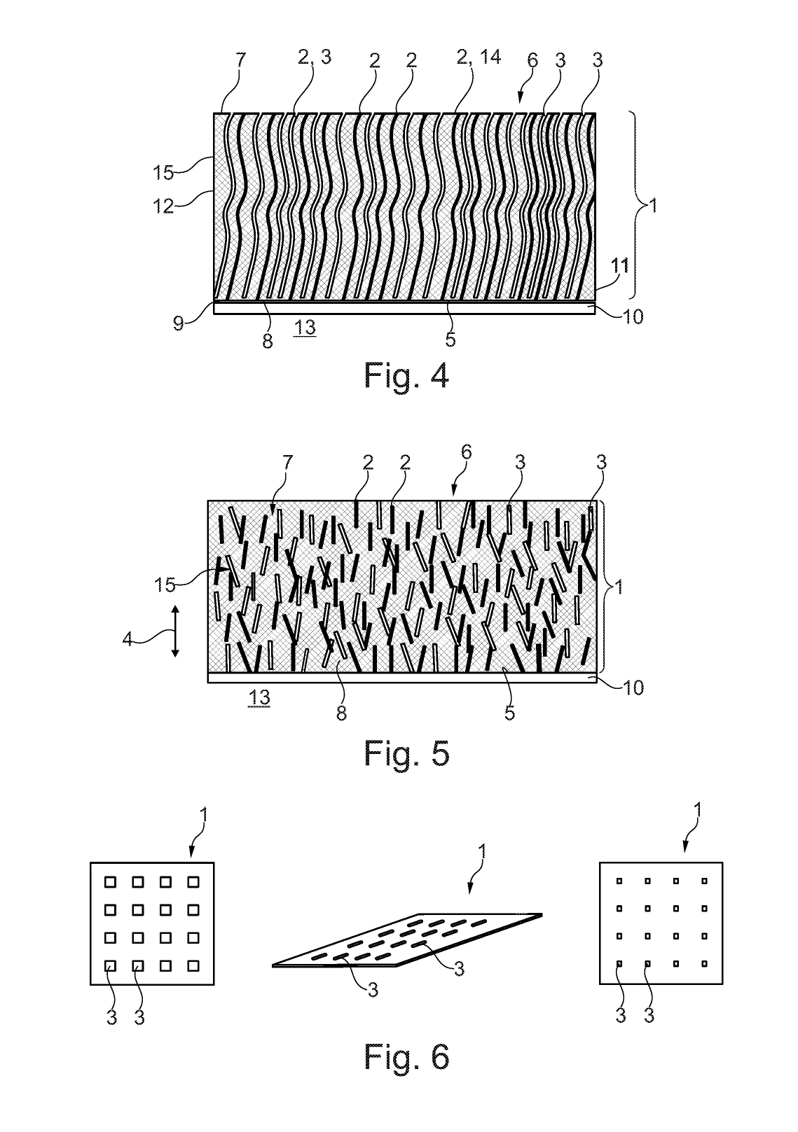

According to FIG. 2, the thermal connection between adsorber structure 1 and heat exchanger wall 13 may also be established by a non-positive contact, although the adsorber structures 1 according to FIG. 1 as well as FIGS. 3 and 4 have an adhesive layer 9 that is highly thermally conductive and/or thin.

A consideration of the adsorber structure 1 according to FIG. 4, reveals that it is divided into two layers 11 and 12. First layer 11 contains a higher, or very high proportion of thermally conductive particles 8, preferably consisting of expanded graphite or graphite powder, BN, SiC, or AlN. In this content, a high content may mean>30 M.-%. Second layer 12 contains a large proportion of highly porous adsorbent powder and a binder, on the basis of alumosilicates, for example. In the lowest area of adsorber structure 1, which creates the thermal contact with heat exchanger surface 5, the powder mixture to be introduced into the interstitial spaces between the fibres thus has a higher proportion of readily thermally conductive particles 8 for the purpose of improving the thermal contact between thermally conductive fibres 2 and surface 5, that is to say the contact surface with a later wall of heat exchanger element 10. The interstitial spaces between the fibres above this layer preferably have high proportions of highly porous adsorbent powder and a binder, to obtain high adsorption capacity. High proportions of adsorbent powder means mass fractions greater than 50%, preferably greater than 75%. In order to improve processability, the mixture may contain still further auxiliary substances. Because of the elevated content of thermally conductive auxiliary substances, that is to say thermally conductive particles 8 in first layer 11, a larger contact area and considerably improved thermal bonding of fibres 2 to wall 10 is possible. The dry or aqueous two-layer composite mass of adsorber structure 1 may undergo further treatment by compacting, cutting, drying, possibly removing adhesive layer 9, and sintering to create finished adsorption bodies, which in a final process are bonded in known manner to form a thermally conductive force-fit or adhesive connection with heat exchanger element 10. Since it is possible for all process steps to be performed automatically in the plane of the contact surface in an endless loop passthrough system, extremely low manufacturing costs may be achieved.

FIG. 4 shows a further design variant of adsorber structure 1, in which fibres 2 that are considerably shorter than the thickness of adsorber structure 1 are use. These fibres may be in the form of chopped fibres with uniform length or also as milled fibres with a certain length variation. Through an extrusion process in the thickness direction, that is to say in gradient direction 4, according to experience in producing fibre composite materials in which shearing and stretching forces are exploited by accelerating the extrudate in a conical die, said fibres 2 are predominantly aligned in this direction. In this context, the aligning effect may be enhanced further by dividing the external cross section into smaller conical exit cross sections and implementing shearing meshes and the like upstream. In order to create thermal contactability, an adsorber structure 1 produced in this way must be cut into slices perpendicularly to the extrusion direction, that is to say perpendicularly to gradient direction 4. When a pasty or thixotropic mass is created, this is easily possible with the aid of a cutting wire, for example. The fibres 2 that are introduced may be selected in terms of composition, material, mass fractions and geometry such that optimally balanced heat and matter transport is established in the final, sintered state.

The following substances are particularly suitable for producing the fibres 2 that leave behind the vapour channels 3 following pyrolysis and/or sintering: polymer-based fibres of polyamide, polyester or polyethylene. Polymers such as polystyrene and SAN, polyamides (PA) such as PA 66, polycarbonate and polyester carbonate, aromatic polyesters (polyarylates), polyimides (PI) such as polyether imide (PEI) or modified polymethacryl imide (poly-(N-methylmethacryl imide), PMMI), polyoxymethylene (POM) and polyterephthalate (PETP, PBTP), also copolymers of said polymers and polyethylene, polypropylene and phenolic resins can be pyrolysed particularly readily. With regard to the thermally conductive fibres 2, PAN- or pitch-based carbon fibres are particularly preferred, but highly metal or ceramic fibres and whiskers with good thermal conductivity are also suitable.

A further variant of the manufacturing method based on the extrusion process consists in extruding a mixture that contains the thermally conductive fibres 2, the adsorber material 7 and the binder, and optionally additional auxiliary substances and in which the transport channels, that is to say the vapour channels 3 are created by the tool during the extrusion process. Moreover, the vapour channels 3 created by the extrusion process may be reduced in cross section, as shown in FIGS. 6b and 6c, defining the body of adsorber structure 1 by moulding and/or compacting it while it is still pasty and can be kneaded and moulded to yield a defined final geometry, before or after cutting to length. FIG. 6a shows the vapour channels 3 before they are deformed. For example, a channel structure or transport structure 15 may be created that is generated by squeezing or plastic reshaping of a honeycomb structure with square channels 3, having a channel width of 1.17 mm and a wall thickness of 330 μm, corresponding to a cell density of 300 cells/inch². Depending on the direction of the subsequent reshaping, vapour channels 3 may be narrowed considerably to an optimum dimension (FIG. 6, c). In this context, vapour channels 3 may also be reshaped to form rhomboids. With these measures, an optimal combination of high vapour diffusion capacity and high volume-specific adsorbent mass may be reached.

The adsorber structure 1 according to the invention with fibres 2 and vapour channels 3 created therefrom by pyrolysis is capable of improving sorption kinetics significantly. As a result, the cycle time may be shortened correspondingly for unchanged driving temperature and pressure differentials, thereby increasing the power density of adsorber structure 1 and of the system, and thus enabling the construction size and system costs to be lowered. At the same time or alternatively, the driving differentials may be reduced for the same cycle time thereby significantly enhancing the plant's coefficient of performance (COP).

With a shortened cycle time and the correspondingly increased power density of sorption modules, it becomes possible to expand the potential application range, including into the automotive sector, with its extremely constricted installation space requirements. The greater power density also contributes to reducing consumption of valuable resource such as the adsorber material 7, steel, and stainless steel.

1. An adsorber structure for an adsorption heat exchanger, comprising directed transport structures for the transport of at least one of heat and adsorptive vapours, wherein the transport structures are substantially aligned in a gradient direction.

2. An adsorber structure according to claim 1, wherein the transport structures are formed by organic fibres that leave behind micro-vapour channels for transporting matter after a pyrolysis process.

3. An adsorber structure according to claim 2, wherein the organic fibres have the form of heat conducting fibres and are connected to a first surface of the adsorber structure, and the vapour channels are closed towards the first surface and are predominantly open to the outside atmosphere toward an opposite, second surface.

4. An adsorber structure according to claim 3, heat conducting fibres are made from at least one of carbon fibres, metal fibres, inorganic fibres or whiskers.

5. An adsorber structure according to claim 2, wherein an adsorber material is arranged between the organic fibres and the vapour channels.

6. An adsorber structure according to claim 3, wherein the organic fibres are substantially perpendicularly incident on the first surface.

7. An adsorber structure according to claim 2, wherein the organic fibres and the vapour channels extend predominantly parallel to each other.

8. An adsorber structure according to claim 2, wherein the organic fibres and the vapour channels are one of linear or serpentine in nature.

9. An adsorber structure according to claim 2, further comprising a first layer with a particle/binder mixture containing thermally conductive particles, and a second layer with a porous adsorbent powder and a binder, the second layer being adjacent to the first layer.

10. An adsorber structure according to claim 9, wherein the first layer is connected to the first surface and the second layer is connected to the second surface.

11. An adsorber structure according to claim 2, wherein the organic fibres are polymer-based fibres of one of polyamide, polyester or polyethylene.

12. An adsorber structure according to claim 11, wherein the organic fibres are made from at least one of polystyrene, SAN, polyamide (PA), PA 66, polycarbonate, polyester carbonate, aromatic polyesters (polyarylates), polyimides (PI), polyether imide (PEI), modified polymethacryl imide, poly-(N-methylmethacryl imide), PMMI, polyoxymethylene (POM), polyterephthalate (PETP, PBTP), copolymers of said polymers, polyethylene, polypropylene, or phenolic resin.

13. An adsorber structure according to claim 2, wherein the organic fibres are shorter than a thickness of the adsorber structure.

14. An adsorption heat exchanger comprising:
an adsorber structure having directed transport structures for the transport of at least one of heat and adsorptive vapours, wherein the transport structures are substantially aligned in a gradient direction, and
a heat exchanger element to which the adsorber structure is connected in a thermally conductive manner via fibres in the form of thermally conductive fibres.

15. A method for producing an adsorber structure, comprising:
bonding fibres, made from at least one of a thermally conductive and pyrolysable material and aligned predominantly in a gradient direction of the produced adsorber structure, to an adhesive layer by electrostatic flocking,
filling interstitial spaces between the individual fibres with a mixture of adsorbing and binder particles,
converting the fibres into tubular vapour channels by a pyrolysis process, and
sintering the adsorber structure to form a directed transport structure for transporting both heat and adsorptive vapours.

16. A method according to claim 15, wherein the interstitial spaces in two particle layers of different compositions are filled out, specifically with a first layer having a particle/binder mixture with high proportions of thermally conductive particles, and with a second layer adjacent thereto and having highly porous adsorbent powder and a binder.

17. A method according to claim 15, wherein the adsorber structure is compacted.

18. An adsorber structure according to claim 1, wherein the adsorber structure is produced by extruding.

19. An adsorber structure according to claim 18, wherein the adsorber structure is compressed such that vapour channels created by at least one of organic and inorganic fibres, or left behind following a pyrolysis process, are reduced in terms of cross section.

20. An adsorber structure according to claim 9, wherein the thermally conductive particles are made from expanded at least one of graphite, graphite powder, BN, SiC and AlN.
